(19) United States
(12) Patent Application Publication
(10) Pub. No.: US 2022/0030915 A1
(43) Pub. Date: Feb. 3, 2022

(54) PET FOODS MADE BY RETORTING AT LEAST ONE OF YOGURT, CHEESE, ANIMAL MILK, OR PLANT MILK; AND METHODS OF MAKING AND USING SUCH PET FOODS

(71) Applicant: Société des Produits Nestlé S.A., Vevey (CH)

(72) Inventors: Stephanie Carole Henriette Daru, Amiens (FR); Claire Molas, Lausanne (CH)

(21) Appl. No.: 17/380,100

(22) Filed: Jul. 20, 2021

Related U.S. Application Data
(60) Provisional application No. 63/057,602, filed on Jul. 28, 2020.

(51) Int. Cl. A23K 40/00; A23K 50/45; A23K 50/48; A23K 10/30; A23K 20/163

(52) U.S. Cl. CPC A23K 40/00; A23K 50/45; A23K 20/163; A23K 10/30; A23K 50/48

(57) ABSTRACT

A method of manufacturing a pet food may include retorting a composition comprising at least one material selected from the group consisting of (i) yogurt, (ii) cheese and (iii) a combination of one or more hydrocolloids and at least one of an animal milk or a plant-based dairy alternative to form the shelf-stable pet food. A product may include the pet food and also a container housing the pet food, the container including instructions to administer the pet food to a pet, preferably a companion animal, most preferably a cat. A method of providing nutrition to a pet may include administering the pet food to a pet, preferably a companion animal, most preferably a cat. The pet food optionally consists of the retorted material. The pet food optionally is low in lactose or lactose-free and optionally includes no added sugar relative to that in the material subjected to the retorting.

### CROSS REFERENCE TO RELATED APPLICATIONS

This application claims priority to U.S. Provisional Application Ser. No. 63/057,602 filed Jul. 28, 2020, the disclosure of which is incorporated in its entirety herein by this reference.

### BACKGROUND

The present disclosure relates generally to shelf-stable pet foods. More specifically, the present disclosure is directed to pet foods made by made by retorting at least one of yogurt, cheese, animal milk, or a plant-based dairy alternative.

There are many pet food products on the market. The pet food products may be in a variety of shapes and structures such as kibbles, biscuits, rawhide products and meat emulsion products. Some wet pet food offers shelf-stable meat products for pets as a complete food.

Nevertheless, some cat and dog owners occasionally feed dairy-based human foods to their pet. For example, pet owners sometimes give small pieces of cheese to the pet, allow the pet to lick a yogurt container after the container has been emptied, or feed small pieces of butter to the pet.

### SUMMARY

Although there are a few dairy-based pet foods on the market, to the best knowledge of the present inventors, there are no pet food products offering a shelf stable dairy range with different appealing textures for both the pets and their owners. Further, there are very few pet food products, if any, that offer a range of different dairy or plant-based dairy alternative ingredients. Dog and cats may have issues digesting lactose, therefore pet foods containing plant-based dairy alternative ingredients and dairy-based pet foods with low or no lactose are attractive options. The present inventors recognized that yogurt, cheese, and animal milk or a plant-based dairy alternative may be a suitable base for a pet food. In some embodiments, a yogurt or cheese may be processed into the pet food (i) with minimal or even no additional ingredients beyond the yogurt or cheese and/or (ii) minimal or even no ingredients removed from the yogurt or cheese. For example, the pet food may contain very low quantity of sugar added to the yogurt and, in some embodiments, may even contain no sugar added to that already present in the yogurt. Additionally or alternatively, when a liquid animal milk or liquid plant-based dairy alternative is used as the base, one or more hydrocolloids may be added to liquid.

The yogurt, cheese, and/or liquid mixture of one or more hydrocolloids with animal milk or plant-based dairy alternative may be retorted to produce a shelf stable pet food. In some embodiments, the resultant pet food is a solid cake, optionally with a whey liquid visually distinct from the cake, that may be administered to the pet without addition of any further ingredients. In other embodiments, the resultant pet food is a liquid that may be administered to the pet as a topping on dry pet food such as kibbles.

Accordingly, in a general embodiment, the present disclosure provides a method of manufacturing a pet food. The method comprises retorting a composition comprising at least one material selected from the group consisting of (i) yogurt, (ii) cheese and (iii) a mixture of one or more hydrocolloids and at least one of an animal milk or a liquid plant-based dairy alternative to form the pet food. The method may further comprise providing the pet food in a container comprising instructions to administer the dairy-based or plant-based dairy alternative pet food to a pet, preferably a companion animal, most preferably a cat.

In another embodiment, the present disclosure provides a product comprising a pet food selected from the group consisting of (i) a retorted yogurt, (ii) a retorted cheese and (iii) a retorted mixture of one or more hydrocolloids and at least one of an animal milk or a liquid plant-based dairy alternative; and the product further comprises a container comprising instructions to administer the dairy-based or plant-based dairy alternative pet food to a pet, preferably a companion animal, most preferably a cat. The pet food is preferably shelf-stable.

In yet another embodiment, the present disclosure provides a method of providing nutrition to a pet. The method comprises administering any of the pet foods disclosed herein to a pet, preferably a companion animal, most preferably a cat.

Therefore, an advantage of one or more embodiments provided by the present disclosure is humanization of pet food, such as food for a cat, for pet owners that enjoy feeding human food to the pet.

Furthermore, an advantage of one or more embodiments provided by the present disclosure is a dairy-based pet food, such as food for a cat.

Still further, an advantage of one or more embodiments provided by the present disclosure is a plant-based dairy alternative pet food, such as food for a cat.

Yet further, an advantage of one or more embodiments provided by the present disclosure is a pet food for cat owners who are more indulgent-oriented and permissive for cat feeding, for example cat owners who may feed their cats a diet having a main course, a dessert and some treats.

Moreover, an advantage of one or more embodiments provided by the present disclosure is a pet food for cat owners who are health- and nutrition-oriented.

Furthermore, an advantage of one or more embodiments provided by the present disclosure is a pet food suitable for fragile cats with one or more health problems: e.g., overweight, elderly cats with nutrition issues such as need of more care and precise diet, hydration, digestive problems, or milk intolerance.

Still further, an advantage of one or more embodiments provided by the present disclosure is a plant-based dairy alternative pet food suitable for pet owners who avoid dairy-based pet foods due to personal convictions.

Yet further, an advantage of one or more embodiments provided by the present disclosure is a pet food that may be administered by hand by the pet owner, which may be the most sensitive way for an owner to show affection.

Moreover, an advantage of one or more embodiments provided by the present disclosure is a dairy-based pet food that delivers the health benefits of dairy to the pet, such as one or more of calcium for bone building during cat's growth, to preserve the skeleton for elderly cats, and/or teeth preservation; vitamins for energy and or vitality; vitamin A and fat for sleeker coat; a solid texture for teeth hygiene; or probiotics for renewal of intestinal flora.

Furthermore, an advantage of one or more embodiments provided by the present disclosure is a pet food low in lactose or lactose-free to thereby ensure safe digestion for the pet.

Still further, an advantage of one or more embodiments provided by the present disclosure is a pet food that is appetizing for the pet, for example by presenting a new taste and/or a new texture relative to known pet foods.

Yet further, an advantage of one or more embodiments provided by the present disclosure is a dairy-based or plant-based dairy alternative pet food that may be a desirable form, such as a solid or semi-solid in a can; a drink in a pouch; or a topping or sauce in a can or a pouch for addition to another pet food, for example, dry kibbles.

Moreover, an advantage of one or more embodiments provided by the present disclosure is pet foods suitable for various ages of a cat, for example a pet food delivering milk as a source of protein, vitamins and calcium to a kitten to thereby mimic mother's lactation; a pet food supplying energy to a young cat who is mischievous and active; a pet food that is a delightful treat for an indulgent cat or a cat humanized by their owner; a pet food providing vitamin A to a pregnant or lactating female cat that has an increased vitamin A requirement from their condition; a pet food delivering vitamins and nutrition to a mature cat having overweight and/or cardio issues; a pet food achieving hydration and moisturizing to a cat not drinking enough water and/or disliking water; a pet food supplying protein and vitamins to an elderly cat; and combinations thereof.

Furthermore, an advantage of one or more embodiments provided by the present disclosure is a dairy-based pet food that contains a single dairy ingredient or a non-dairy pet food that contains a single plant-based dairy alternative ingredient, which thereby avoids formulations containing numerous components not found in typical pet food and/or avoids excessive processing typically disfavored in pet foods.

Still further, an advantage of one or more embodiments provided by the present disclosure is a pet food that is appetizing for the pet, for example by presenting a new taste and/or a new texture relative to known pet food.

Yet further, an advantage of one or more embodiments provided by the present disclosure is a pet food that may be liquid (e.g., in a pouch or jar for multiple servings) or may be solid/semi-solid like a flan or terrine (e.g., in a can as a complete meal).

Moreover, an advantage of one or more embodiments provided by the present disclosure is a pet food containing natural ingredients and less additional components, for example, no chemical component, and/or no additive such as a taste enhancer.

In some embodiments, the pet food advantageously has a brown color suggestive of caramel, due to the Maillard reaction from retorting, for example a beige color.

Additional features and advantages are described herein, and will be apparent from the following Detailed Description and the Figures.

### BRIEF DESCRIPTION OF THE FIGURES

FIGS. 1A and 1B are photographs of the pet foods resulting from retorting a classical “natural” yogurt with a firm texture in the first experimental example disclosed herein.

FIG. 2 is a photograph of the pet food resulting from retorting a “brassé” yogurt with a fluid creamy texture in the first experimental example disclosed herein.

FIG. 3 is a photograph of the pet food resulting from retorting a “fromage Blanc” yogurt, which is a standard yogurt with addition of cream, in the first experimental example disclosed herein.

FIG. 4 is a photograph of the pet food resulting from retorting a mixture of hydrocolloids and milk in the second experimental example disclosed herein.

FIGS. 5-10 present photographs of pet foods resulting from retorting various materials in a can, from the third experimental example disclosed herein.

FIGS. 11-16 present photographs of pet foods resulting from retorting various materials in a pouch, from the third experimental example disclosed herein.

### DETAILED DESCRIPTION

### Definitions

Some definitions are provided hereafter. Nevertheless, definitions may be located in the “Embodiments” section below, and the above header “Definitions” does not mean that such disclosures in the “Embodiments” section are not definitions.

As used in this disclosure and the appended claims, the singular forms “a,” “an” and “the” include plural referents unless the context clearly dictates otherwise. Thus, for example, reference to “a meat” includes two or more meats.

The term “and/or” used in the context of “X and/or Y” should be interpreted as “X,” or “Y,” or “both X and Y.” Similarly, “at least one of X or Y” should be interpreted as “X,” or “Y,” or “both X and Y.” Where used herein, the terms “example” and “such as,” particularly when followed by a listing of terms, are merely exemplary and illustrative and should not be deemed to be exclusive or comprehensive. Any embodiment disclosed herein may be combined with any other embodiment disclosed herein unless explicitly stated otherwise.

The words “comprise,” “comprises” and “comprising” are to be interpreted inclusively rather than exclusively. Likewise, the terms “include,” “including” and “or” should all be construed to be inclusive, unless such a construction is clearly prohibited from the context.

However, the compositions disclosed herein may lack any element that is not specifically disclosed. Thus, a disclosure of an embodiment using the term “comprising” includes a disclosure of embodiments “consisting essentially of” and “consisting of” the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified.

As used herein, “about,” “approximately” and “substantially” are understood to refer to numbers in a range of numerals, for example the range of −10% to +10% of the referenced number, preferably within −5% to +5% of the referenced number, more preferably within −1% to +1% of the referenced number, most preferably within −0.1% to +0.1% of the referenced number. Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

All percentages expressed herein are by weight of the total weight of the composition unless expressed otherwise. When reference is made to the pH, values correspond to pH measured at 25° C. with standard equipment.

The term “pet” means any animal which could benefit from or enjoy the compositions provided by the present disclosure. For example, the pet may be an avian, bovine, canine, equine, feline, hircine, lupine, murine, ovine, or porcine animal, but the pet may be any suitable animal. The term “companion animal” means a dog or a cat. As used herein, a “kitten” is a cat one year of age or less. As used herein, a “young” cat is more than one year of age up to five years of age. As used herein, a “mature” cat is more than five years of age up to ten years of age. As used herein, an “elderly” cat is at least ten years of age.

The terms “food,” “food product” and “food composition” mean a product or composition that is intended for ingestion by an animal, including a human, and provides at least one nutrient to the animal. The term “pet food” means any food composition intended to be consumed by a pet.

The terms “dairy-based milk” or “animal milk” or “dairy milk” mean a nutrient-rich liquid food produced by mammals. Animal milks contains many nutrients including protein and lactose. Mammals that can produce dairy milk include, but are not limited to, buffaloes, camels, cows, ewes, goats, mares, reindeer, and yaks.

The terms “plant-based dairy alternative” or “dairy alternative” or “plant milk” or “plant-based milk” or “nondairy ingredient” are used interchangeably herein and mean a plant-based liquid extract that can be used as an alternative to dairy milk produced by mammals. Non-limiting sources of plant-based milks include, grains, pseudocereals, legumes, nuts, seed or coconut; for example, barley, fonio, maize, millet, oat, rice, rye, sorghum, teff, triticale, spelt, wheat, amaranth, buckwheat, quinoa, lupin, pea, peanut, soy, almond, brazil nut, cashew, hazelnut, macadamia, pecan, pistachio, walnut, chia seed, flax seed, hemp seed, pumpkin seed, sesame seed, sunflower seed, coconut, potato, and tiger nut. Such plant derived liquid extracts often provide a mouthfeel similar to dairy based milks, thus can be an attractive alternative for those with lactose intolerance or those with other reasons for avoiding or minimizing consumption of animal-based milks.

The term “low lactose” or “low in lactose” refers to compositions comprising less lactose than is present in animal milks. In some embodiments, low lactose compositions comprise less than about 4.0 wt. % lactose, less than about 3.0 wt. % lactose, less than about 2.0 wt. % lactose or less than about 1.0 wt. % lactose.

The term “shelf-stable” means the pet food is capable of being stored at room temperature (e.g., about 20° C. to about 25° C.) for at least three months while keeping approximately the same viscosity and staying safe for pet consumption. In some embodiments a shelf stable pet food is capable of being stored at room temperature for at least six months, at least 12 months, at least 18 months or at least 24 months.

“Wet food” is pet food having a moisture content from about 50% to about 90%, preferably from about 70% to about 90%. “Dry food” is pet food having a moisture content less than about 20%, less than about 15%, or less than about 10%. “Kibbles” are pellets of dry pet food.

As used herein, a pet food having a “brown color” is a pet food in which at least a majority of the exterior surface has an sRGB^{B} (r, g, b) of about (150, 75, 0). For example, a pet food having a brown color preferably has at least a majority of the exterior surface having one or more of: beaver color (159, 129, 112), beige color (245, 245, 220), buff color (240, 220, 130), burnt umber color (138, 51, 36), chestnut color (149, 69, 53), chocolate color (123, 63, 0), cocoa brown color (210, 105, 30), dark brown color (36, 25, 20), desert sand color (237, 201, 175), khaki color (195, 176, 145), kobicha color (107, 68, 35), peru color (205, 133, 63), raw umber color (130, 102, 68), rosy brown color (188, 143, 143), russet color (128, 70, 27), sandy brown color (244, 164, 96), smokey topaz color (131, 42, 13), tan color (210, 180, 140), taupe color (72, 60, 50), walnut brown (92, 82, 72) or wenge color (193, 154, 107).

Unless defined otherwise, all technical and scientific terms, terms of art, and acronyms used herein have the meanings commonly understood by one of ordinary skill in the art in the field(s) of the present disclosure or in the field(s) where the term is used. Although any compositions, methods, articles of manufacture, or other means or materials similar or equivalent to those described herein may be used, the preferred devices, methods, articles of manufacture, or other means or materials are described herein.

### Embodiments

In a general embodiment, a method of manufacturing a pet food comprises retorting a composition comprising at least one material selected from the group consisting of (i) yogurt, (ii) cheese and (iii) a mixture of one or more hydrocolloids and at least one of an animal milk or a plant-based dairy alternative to form the pet food. The method may further comprise providing the pet food in a container comprising instructions to administer the pet food to a pet, preferably a companion animal, most preferably a cat.

In some embodiments disclosed herein, the pet food may be made by retorting yogurt and/or cheese, may comprise a solid cake and a whey liquid, and may be administered to the pet without addition of any further ingredients. In other embodiments, the pet food may be made by retorting a mixture of one or more hydrocolloids and at least one of an animal milk or a plant milk, may be a liquid, and may be administered to the pet either without addition of any further ingredients or as a topping on dry pet food such as kibbles.

Therefore, a first aspect of the present disclosure is a method of manufacturing a solid shelf-stable pet food containing dairy and/or plant-based dairy alternative, the method comprising retorting at least one of yogurt or cheese. The yogurt and/or cheese may be positioned in a suitable container and then the container may be sealed and retorted. In some embodiments the resultant solid shelf-stable pet food containing dairy and/or plant-based dairy alternative comprises a semi-solid or solid cake consisting of the retorted yogurt and/or cheese; although in some embodiments, additional ingredients may optionally be added to the retorted yogurt and/or cheese, and/or further processing may optionally be performed. The solid cake may substantially retain its shape when removed from the container.

The pet food may further comprise a whey liquid that is no greater than about 20.0 wt. % of the cake, no greater than about 10.0 wt. % of the cake, no greater than about 5.0 wt. % of the cake, or no greater than about 1.0 wt. % of the cake.

Non-limiting examples of suitable containers include metal cans (e.g., 3 oz. 85 g cans), plastic trays, tubs, seamed packagings (e.g., a seamed can in which a can end is interlocked with a can body), flexible pouches, glass jars, or retortable rigid plastic containers. The present disclosure is not limited to a specific embodiment of the packaging, and preferably the packaging is any container that may receive the yogurt and/or cheese and then withstand retorting conditions.

In some embodiments, the retorting of the yogurt and/or cheese to form the solid pet food is performed in a metal can (e.g., a 3 oz. 85 g can) for a time between about 10 minutes and about 40 minutes at a temperature between about 120° C. and about 130° C. at a pressure between about 1.0 bar and about 3.0 bar, for a time between about 20 minutes and about 30 minutes at a temperature between about 123° C. and about 125° C. at a pressure between about 1.5 bar and about 2.0 bar, or for about 28 minutes at about 124° C. at about 1.8 bar.

The resultant solid shelf-stable pet food containing dairy and/or plant-based dairy alternative may be administered to a pet, for example a companion animal such as a cat. In embodiments in which the solid pet food is stored in a container (e.g., a container in which the pet food was retorted), the solid pet food may be provided to the pet by opening the container and administering the pet food to the pet, for example, without addition of any further ingredients.

As used herein, the “yogurt” that is retorted is a product that is a fermented animal milk or plant-based dairy alternative. Typically the animal milk or plant-based dairy alternative is fermented with a combination of strains of Streptococcus thermophilus and Lactobacillus bulgaricus, but the yogurt processed herein is not limited to these cultures. In some embodiments, the yogurt is a gel containing the strains, either living or heat-treated.

Non-limiting examples of suitable animal milks for fermentation into yogurt include cow's milk; milk from one or more of buffalo, goats, ewes, mares, camels, and yaks; and mixtures thereof. In some embodiments, cream, whole milk, partially skimmed milk, or skim milk are fermented alone or in combination; optionally one or more of concentrated skim milk, nonfat dry milk, buttermilk, whey, lactose, lactalbumins, lactoglobulins, or whey modified by partial or complete removal of lactose and/or minerals may be added to increase the non-fat solids content of the yogurt as long as both the ratio of protein to total non-fat solids of the yogurt and the protein efficiency ratio of all protein present in the yogurt is not decreased by the optional additional ingredient.

Non-limiting examples of suitable plant-based dairy alternatives, also known as plant milks, vegetable milks, vegan milks and nut milks, for fermentation into yogurt include extracts or “milk” from one or more of legume, nut, seed, grain, or coconut. In some embodiments, the plant-based liquid is one or more of coconut milk, almond milk, soy milk, or hazelnut milk.

Other optional ingredients in yogurt additional to the fermented milk include vitamins such as vitamin A and vitamin D, nutritive carbohydrate sweetener, flavoring ingredients, color additives, and stabilizers. Non-limiting examples of suitable nutritive carbohydrate sweeteners include sugar (sucrose), beet or cane; invert sugar (in paste or syrup form); brown sugar; refiner's syrup; molasses; high fructose corn syrup; fructose; fructose syrup; maltose; maltose syrup, dried maltose syrup; malt extract, dried malt extract; malt syrup, dried malt syrup; honey; maple sugar.

In some embodiments, the yogurt consists of the fermented animal milk or fermented plant-based dairy alternative, the bacteria, and optionally one or more of vitamins, nutritive carbohydrate sweetener, flavoring ingredients, color additives, or stabilizers.

In embodiments of yogurt based on animal milk, the yogurt may comprise about 1.0 wt. % to about 10.0 wt. % protein from the fermented animal milk, about 2.0 wt. % to about 8 wt. % protein from the fermented animal milk, about 2.5 wt. % to about 7.0 wt. % protein from the fermented animal milk, or about 3.0 wt. % to about 5.0 wt. % protein from the fermented animal milk. In embodiments based on animal milk, the yogurt may comprise at least 3.25 wt. % milkfat and at least 8.25 wt. % milk solids non-fat (MNSF) from the fermented animal milk.

In embodiments of yogurt based on animal milk, the yogurt may comprise about 4.0 wt. % to about 7.5 wt. % lactose from the fermented animal milk, or about 5.0 wt. % to about 7.0 wt. % lactose from the fermented animal milk. In other embodiments, the yogurt based on animal milk may comprise less than about 4.0 wt. % lactose, less than about 3.0 wt. % lactose, less than about 2.0 wt. % lactose, less than about 1.0 wt. % lactose, less than about 0.1 wt. % lactose or less than about 0.01 wt. % lactose. As used herein, “cheese” means a product made by adding starter bacteria cultures to milk. The bacteria ferment the lactose in the milk into lactic acid. Subsequently rennet extract is added to the inoculated milk, and the lactic acid produced by the bacteria activates the rennin enzyme in the rennet. Most cheese-making methods involve waiting fifteen to sixty minutes after the starter bacteria is added to the milk before adding the rennet so that the bacteria acclimate themselves to their new environment in preparation for rapid growth and produce an initial amount of lactic acid.

A second aspect of the present disclosure is a method of manufacturing a shelf-stable pet food containing animal milk and/or plant-based dairy alternative, the method comprising retorting a combination of one or more hydrocolloids with the animal milk and/or plant-based dairy alternative. In an embodiment, the one or more hydrocolloids are selected from the group consisting of starches, guar gum, pectin, gelatin, carrageenan, agar, acacia gum, sodium alginate, xanthan gum, locust bean gum, carboxymethyl cellulose (CMC) or a combination thereof. Non-limiting examples of suitable starches include one or more of potato starch, wheat starch, tapioca starch, corn starch and rice starch.

The one or more hydrocolloids may be present in an amount sufficient for the mixture with the animal milk and/or plant-based dairy alternative to have a viscosity of at least 2,000 cps. In a one embodiment, the one or more hydrocolloids is a mixture of starch and guar gum, for example a mixture of about 1.0 wt. % guar gum and about 0.7 wt. % starch, and optionally the remainder of the mixture is the animal milk and/or plant-based dairy alternative.

Non-limiting examples of suitable animal milks for combination with the one or more hydrocolloids include cow's milk; milk from one or more of buffalo, goats, ewes, mares, camels, and yaks; and mixtures thereof. Preferably cream, whole milk, partially skimmed milk, or skim milk are used, optionally after partial or complete removal of lactose. Non-limiting examples of suitable plant-based dairy alternatives for combination with the one or more hydrocolloids include liquid extracts, “plant milk,” from one or more of legume, nut, seed, grain, or coconut. In some embodiments, the plant milk is one or more of coconut milk, almond milk, soy milk, or hazelnut milk.

The combination of the one or more hydrocolloids with the animal milk and/or plant-based diary alternative may be positioned in a suitable container and then the container may be sealed and retorted. The resultant shelf-stable pet food may have the form of a drinkable liquid consisting of the retorted combination of the one or more hydrocolloids with the at least one of an animal milk or a plant-based dairy alternative; although in some embodiments, additional ingredients may optionally be added to the retorted combination of the one or more hydrocolloids with the animal milk and/or plant-based dairy alternative, and/or further processing may optionally be performed.

Non-limiting examples of suitable containers include metal cans (e.g., 3 oz. 85 g cans), plastic trays, tubs, seamed packagings (e.g., a seamed can in which a can end is interlocked with a can body), flexible pouches, glass jars, or retortable rigid plastic containers. The present disclosure is not limited to a specific embodiment of the packaging, and preferably the packaging is any container that may receive the combination of one or more hydrocolloids with at least one of an animal milk or a plant-based diary alternative and then withstand retorting conditions.

In some embodiments, the retorting of the combination of the one or more hydrocolloids with the animal milk and/or plant-based dairy alternative is performed in a flexible pouch (e.g., a 100 g pouch) for a time between about 12 minutes and about 30 minutes at a temperature between about 120° C. and about 135° C. at a pressure between about 1.0 bar and about 3.0 bar, for a time between about 15 minutes and about 20 minutes at a temperature between about 125° C. and about 130° C. at a pressure between about 1.5 bar and about 2.0 bar, or for about 17 minutes at about 128° C. at about 1.8 bar.

The resultant shelf-stable pet food containing dairy and/or plant-based dairy alternative may be administered to a pet, for example a companion animal such as a cat. In embodiments in which the pet food is stored in a container (e.g., a pouch, jar or can in which the pet food was retorted), the pet food may be provided to the pet by opening the container and administering the pet food to the pet, preferably without adding any further ingredients after the retorting of the container by the manufacturer until the opening of the container by the consumer. In some embodiments, no further ingredients are added by the consumer after the opening of the container. In other embodiments, which are particularly advantageous if the pet food is a liquid, the pet food may be added to a different pet food such as dry kibbles before feeding the animal.

In some embodiments, the container is configured for a consumer to close the container with a portion of the pet food still therein after the administering, for example by a seal or lid of the container. In such embodiments, a single unit of the pet food may provide multiple servings and thus may limit waste (e.g., uneaten food exposed to conditions outside of the container.

Yet another aspect of the present disclosure is method of providing nutrition to a pet, such as a companion animal, by administering any of the shelf-stable pet foods disclosed herein. In some embodiments, the pet food is formulated for a pet such as a companion animal, for example according to the standards of The Association of American Feed Control Officials (AAFCO).

In view of these disclosures, a method of manufacturing a pet food may comprise retorting a composition comprising at least one material selected from the group consisting of (i) yogurt, (ii) cheese and (iii) a combination of one or more hydrocolloids and at least one of an animal milk and a plant-based dairy alternative to form the pet food. The method may further comprise providing the pet food in a container comprising instructions to administer the pet food to a pet, a companion animal, for example, a cat. The at least one material may be retorted in the container. The pet food may have a characteristic selected from the group consisting of (a) free of dairy and (b) only one single dairy ingredient. The pet food may contain no added sugar relative to that present in the at least one starting material; and may contain no additional ingredients relative to the at least one starting material, such that the pet food consists of the retorted material. The pet food may contain less than 1.0 wt. % lactose, less than 0.1 wt. % lactose, less than 0.01 wt. % lactose, or no lactose.

A product may comprise any of these pet foods, in a container comprising instructions to administer the pet food to a pet, a companion animal, for example, a cat. The pet food may be shelf-stable. The pet food may have a form selected from the group consisting of (a) a semi-solid or solid cake with a whey liquid and (b) a liquid. The container may be selected from the group consisting of a can, a jar, and a pouch.

A method of providing nutrition to a pet may comprise administering any of these pet foods to the pet. The method may comprise opening a container housing the pet food before the administering. The pet food may be administered to the pet without addition of any further ingredients after the opening of the container or with addition to another pet food, preferably dry kibbles. The pet may be selected from the group consisting of a kitten, a young cat, a mature cat, and an elderly cat. The pet may have at least one condition selected from the group consisting of pregnant female, lactating female, overweight, cardio issues, digestive problems, milk intolerance, and need of hydration.

### EXAMPLES

The following non-limiting examples are illustrative of embodiments provided by the present disclosure and advantages thereof.

### Example 1

Processing by a retort system on a “fresh” yogurt was investigated. Specifically, three types of yogurt were dosed into cans in an amount of 85 g and then retorted (T ° C. max=121° C.). The first type of yogurt was a classical “natural” yogurt with a firm texture. The second type of yogurt was a “brassé” yogurt with a fluid creamy texture. The third type of yogurt was a “fromage Blanc” yogurt, which is a standard yogurt with addition of cream.

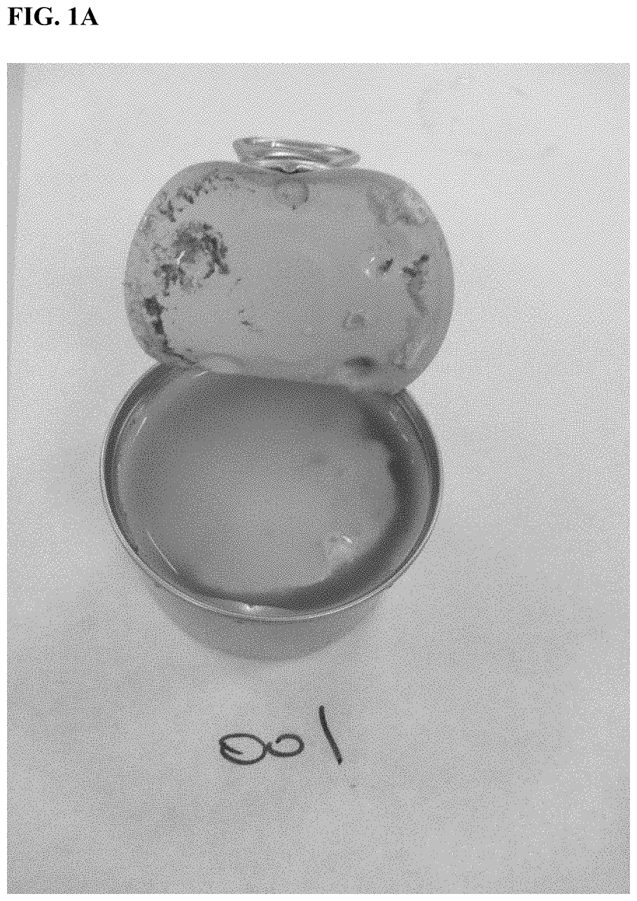

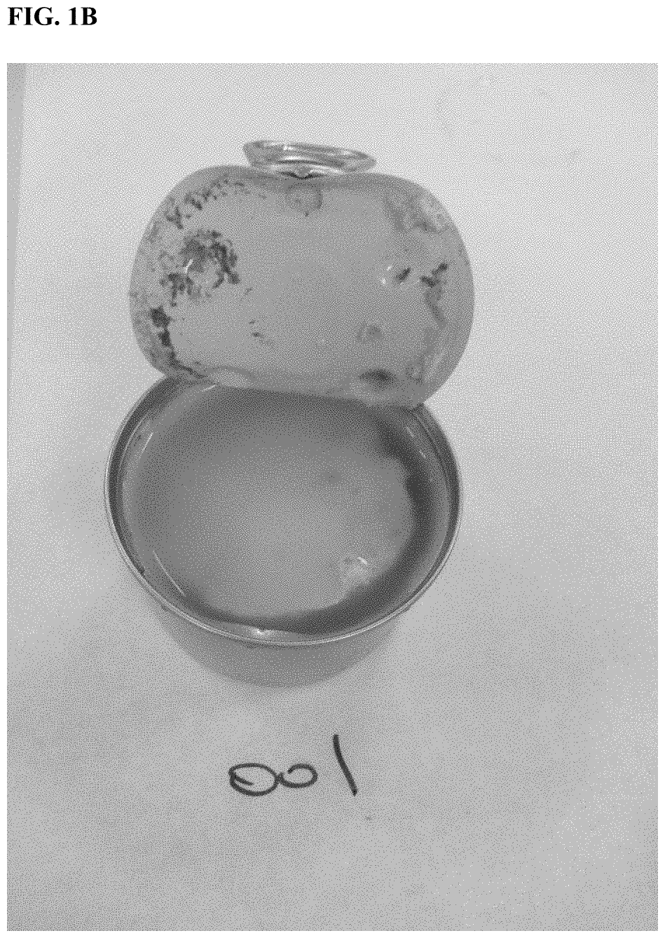

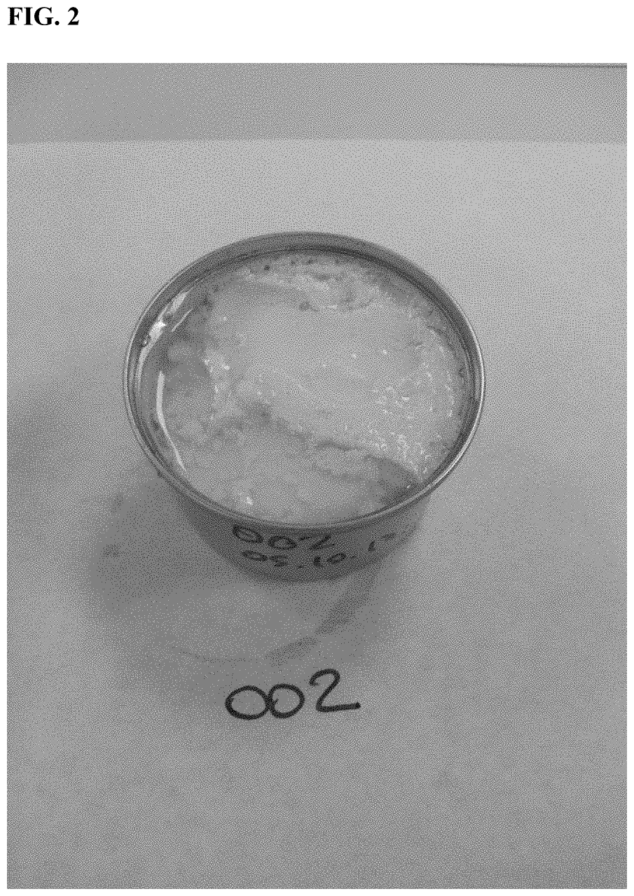

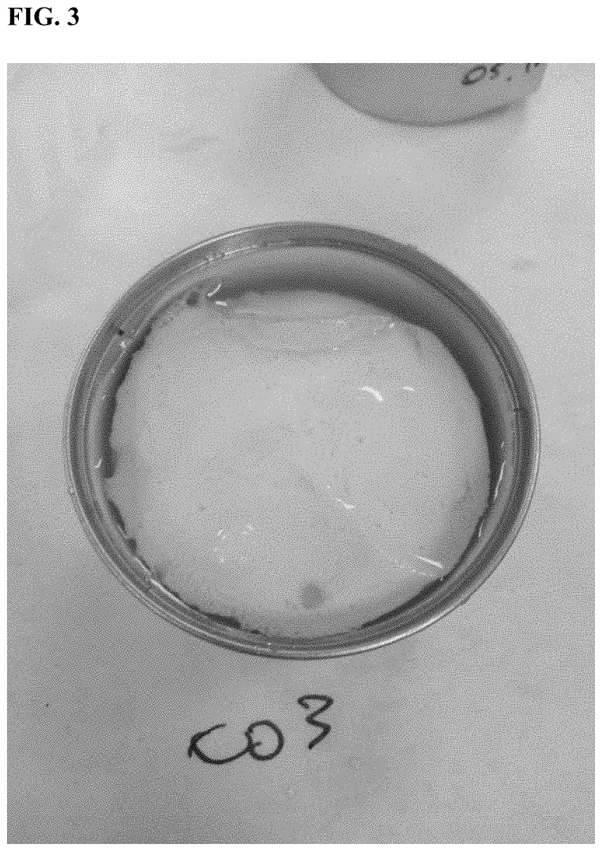

After the retort, the resultant dairy-based products had very interesting cosmetics. In this regard, the whey separated from the other part of the yogurt, and the other part was a solid cake that maintained a structure of a block and had the appearance of fresh cheese. Specifically, FIGS. 1A and 1B show the pet food resulting from retorting the first type of yogurt, FIG. 2 shows the pet food resulting from retorting the second type of yogurt, and FIG. 3 shows the pet food resulting from retorting the third type of yogurt. The products obtained from the three different types of yogurt differed in their color, the amount of whey, and the texture. These products would be particularly suitable as a dairy product for cats, e.g., a treat resembling a cake of cheese.

### Example 2

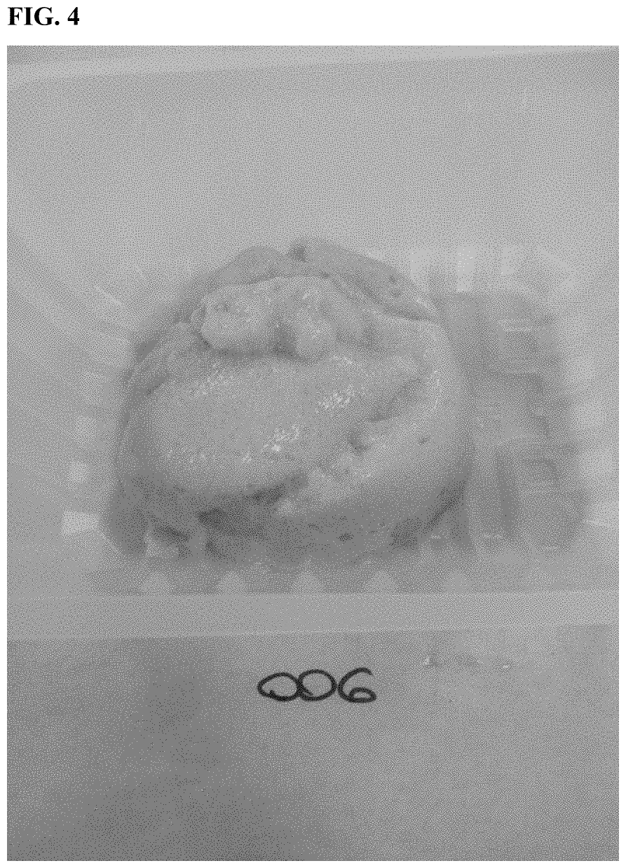

Processing by a retort system on a mixture of whole cow's milk and an amount of hydrocolloids sufficient to provide the mixture with a viscosity of at least 2,000 cps was investigated. Specifically, a mixture containing 1.0 wt. % guar gum, 0.7 wt. % starch and the remainder milk was mixed in a mixer for about two minutes and then dosed into cans in an amount of 85 g and then retorted (T ° C. max=121° C.). After the retort, the resultant dairy-based products had a texture similar to yogurt but slightly more firm (see FIG. 4). Depending on the initial milk used, you have different colors after retort (different level of sugars in the milks).

### Example 3

Different starting materials were investigated, specifically, particular yogurts, animal milks, and plant milks.

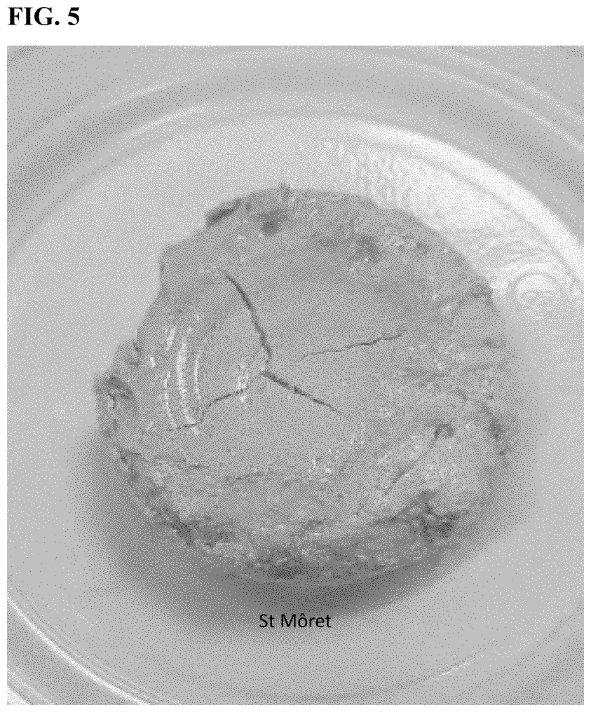

FIG. 5 shows a pet food resulting from retorting, in a can, a composition that was 100% St. Môret cheese. The pet food had a firm and elastic texture, similar to a mousse or a flan; an airy surface with bubbles; and a fermented aroma. This pet food provided a small amount of whey liquid (1.8 ml) separated from the firm and elastic structure, which was pleasantly perceived by pet owners. This pet food may be administered to a cat, e.g., as a full meal for a cat.

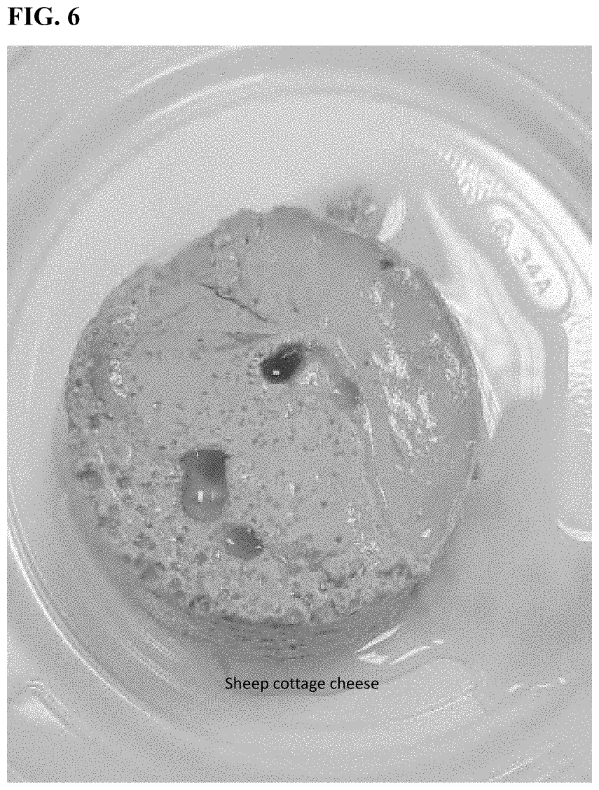

FIG. 6 shows a pet food resulting from retorting, in a can, a composition that was 100% sheep cottage cheese. The pet food had pleasant visible aspect like a pudding or crème brulee, with an elastic and firm texture and an airy effect conveying lightness. This pet food had a caramel aroma and a dark color. This pet food provided a significant amount of whey liquid (3.2 ml) separated from the firm and elastic structure. This pet food may be administered to a cat, e.g., as a snack or treat for a cat.

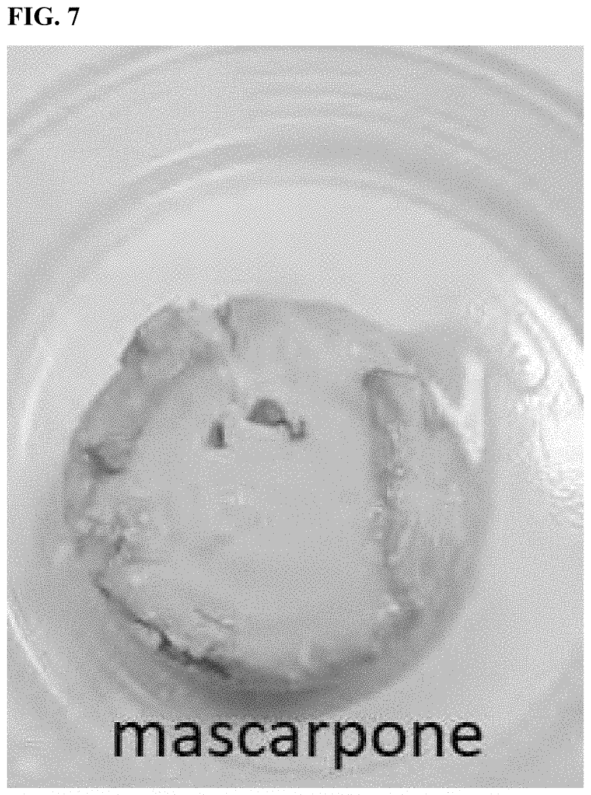

FIG. 7 shows a pet food resulting from retorting, in a can, a composition that was 100% mascarpone. The pet food had a firm consistency and was easy to eat for the cat. The texture was smooth and unctuous, mixing well for pet owners who like mashing the food, and had a caramel and vanilla aroma. This pet food had a pleasant color evoking vanilla, and a small amount of whey liquid (0.7 ml) separated from the firm and elastic structure. This pet food may be administered to a cat, e.g., as a meal for breakfast or mid-day or as a snack at middle of the afternoon.

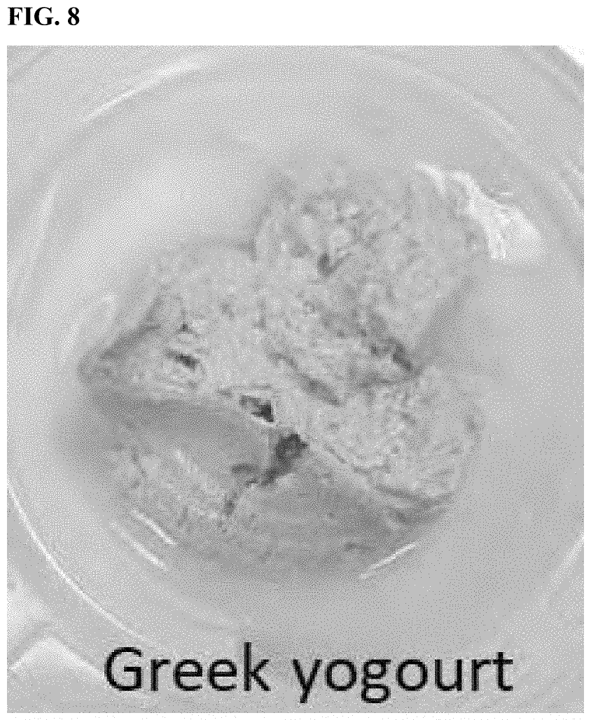

FIG. 8 shows a pet food resulting from retorting, in a can, a composition that was 100% Greek yogurt. The pet food was a combination of a substantial amount of whey liquid (3.4 ml) separated from a soft and elastic structure, providing two functions for the cat: hydration due to the whey liquid and nourishment due to the soft and elastic structure. This pet food had an slight pleasant smell of sourness. This pet food may be administered to a cat, e.g., as a refreshing occasional dessert.

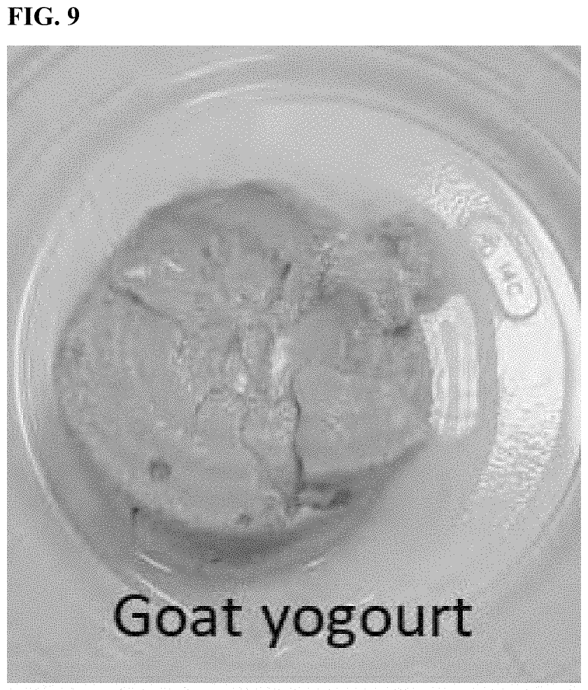

FIG. 9 shows a pet food resulting from retorting, in a can, a composition that was 100% goat yogurt. The pet food had no lactose and was low in fat, with a soft texture. The color was like caramelized flan, with a light pleasant smell of caramel and a light goat cheese fragrance. A significant amount of whey liquid (2.1 ml) separated from the soft structure. This pet food may be administered to a cat, e.g., as an occasional dessert (e.g., not every day) for example as a snack.

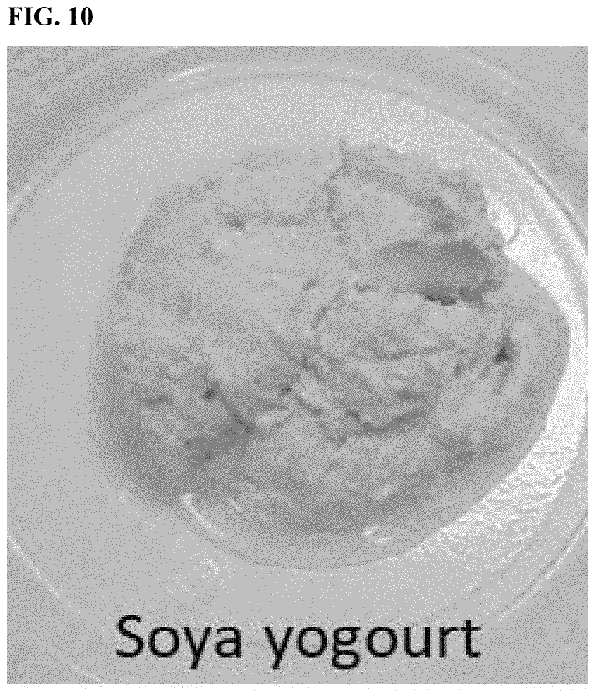

FIG. 10 shows a pet food resulting from retorting, in a can, a composition that was 100% soy yogurt. The pet food was elastic and firm with a small amount of whey liquid (1.4 ml) separating therefrom, and a coherent color throughout that was almost white. This pet food may be administered to a cat.

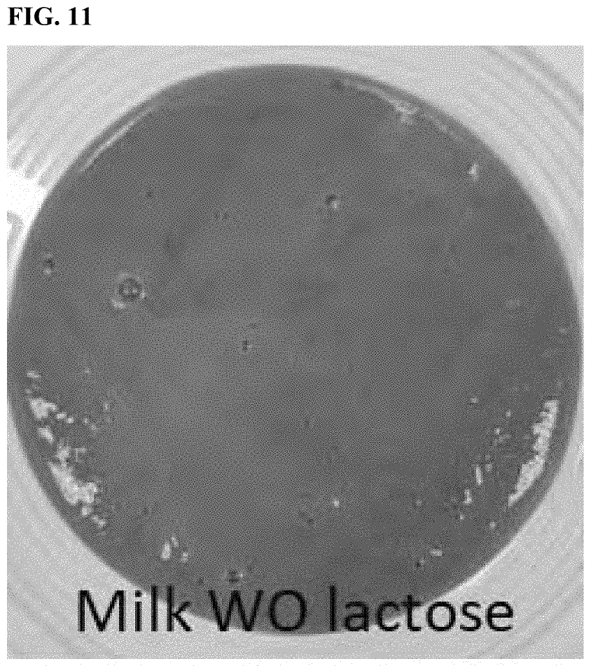

FIG. 11 shows a pet food resulting from retorting, in a pouch, a composition that was 98.3% cow's milk without lactose, 1.0% guar gum and 0.7% starch. The pet food had no lactose, a slightly jellified and heterogeneous texture, a very dark color evoking mocha, and a pleasant sweet caramel smell. This pet food may be administered to a cat, e.g., as a full meal for a cat, for example dinner.

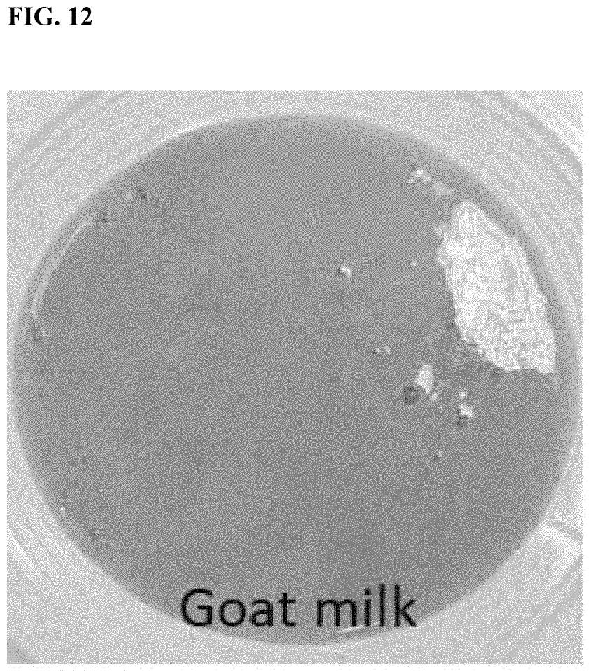

FIG. 12 shows a pet food resulting from retorting, in a pouch, a composition that was 98.3% goat milk, 1.0% guar gum and 0.7% starch. The pet food had a slightly jellified and homogeneous texture, while creamy; a dark color evoking known desserts; and a light smell of goat cheese. This pet food may be administered to a cat, e.g., as a breakfast meal for a cat, for example as a sauce on dry kibbles.

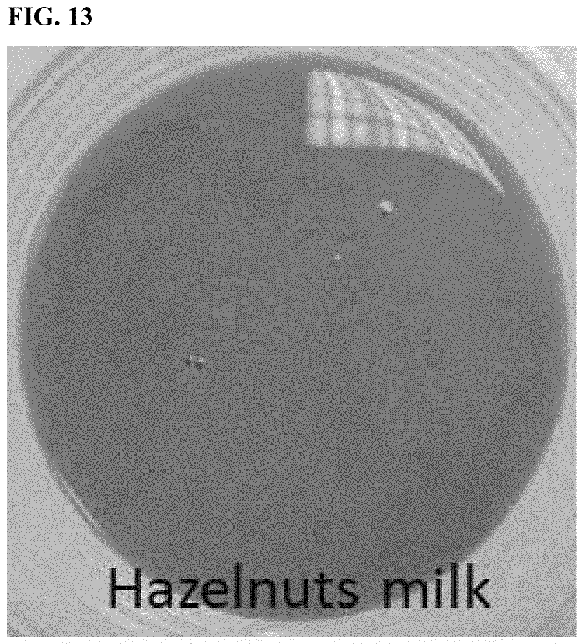

FIG. 13 shows a pet food resulting from retorting, in a pouch, a composition that was 98.3% hazelnut milk, 1.0% guar gum and 0.7% starch. The pet food had no lactose; an unctuous and homogeneous texture, while creamy; and the smell, color and texture of a hazelnut cream dessert. This pet food may be administered to a cat, e.g., as a treat, for example a snack, or as supplement to another pet food.

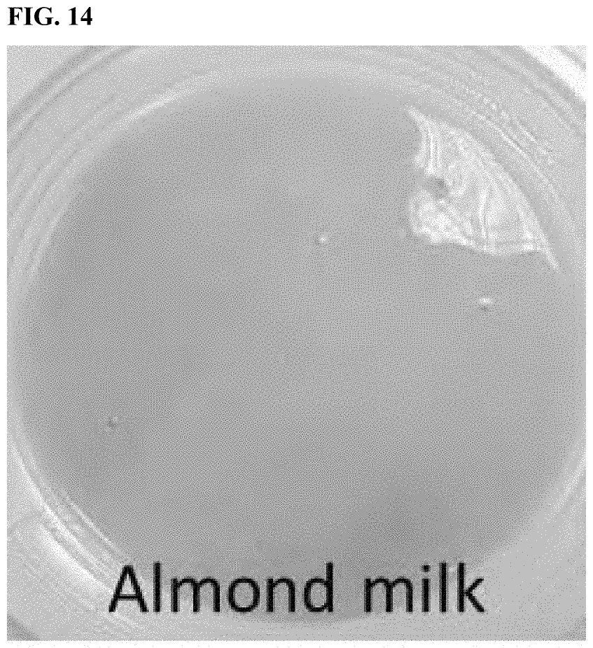

FIG. 14 shows a pet food resulting from retorting, in a pouch, a composition that was 98.3% almond milk, 1.0% guar gum and 0.7% starch. The pet food had a slightly jellified and homogeneous texture, while creamy; and a light color corresponding to almond milk. The aroma was pleasant and discreet, powdery and like soya. This pet food may be administered to a cat, e.g., as a meal, for example breakfast, or as a mid-day snack.

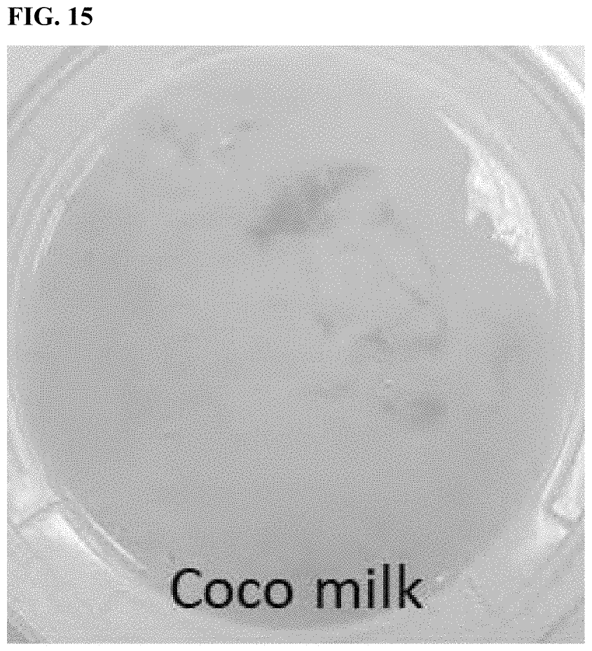

FIG. 15 shows a pet food resulting from retorting, in a pouch, a composition that was 98.3% coconut milk, 1.0% guar gum and 0.7% starch. The pet food had an unctuous and heterogeneous texture which was mild; a pleasant sweet aroma; and a light color that was almost white. This pet food may be administered to a cat, e.g., as a breakfast meal for a cat, for example as a replacement for a glass of milk or as a sauce on dry kibbles, or as a mid-day snack.

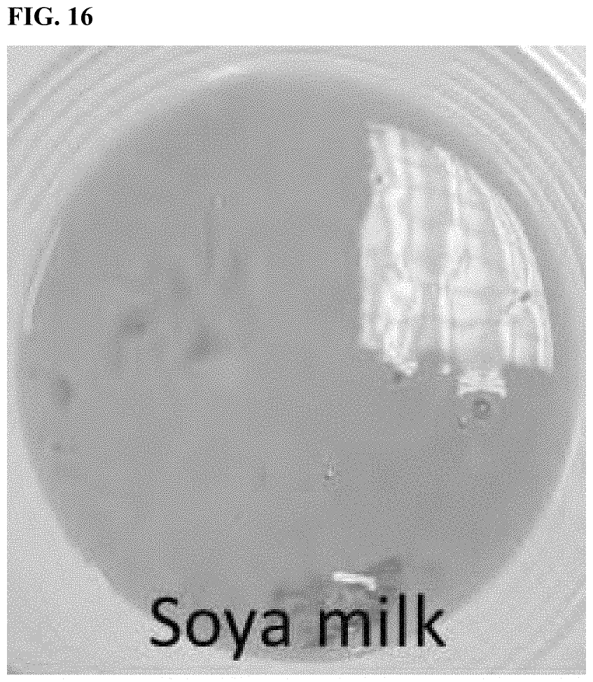

FIG. 16 shows a pet food resulting from retorting, in a pouch, a composition that was 98.3% soy milk, 1.0% guar gum and 0.7% starch. The pet food had an unctuous and heterogeneous texture; a vanilla aroma; and a marbled color. This pet food may be administered to a cat, e.g., as a treat at lunch or mid-afternoon or as a sauce on dry kibbles.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of manufacturing a pet food, the method comprising:
retorting a composition comprising at least one material selected from the group consisting of (i) yogurt, (ii) cheese and (iii) a combination of one or more hydrocolloids and at least one of an animal milk and a plant milk to form the pet food.

2. The method of claim 1, further comprising providing the pet food in a container comprising instructions to administer the pet food to a pet, preferably a companion animal, most preferably a cat.

3. The method of claim 2, wherein the at least one material is retorted in the container.

4. The method of any of claims 1 to 3, wherein the pet food has a characteristic selected from the group consisting of (a) free of dairy and (b) only one single dairy ingredient.

5. The method of any of claims 1 to 4, wherein the pet food contains no added sugar relative to that present in the at least one starting material; and preferably contains no additional ingredients relative to the at least one starting material, such that the pet food consists of the retorted material.

6. The method of any of claims 1 to 5, wherein the pet food contains less than about 4.0 wt. % lactose, less than about 3.0 wt. % lactose, less than about 2.0 wt. % lactose, less than about 1.0 wt. % lactose or no lactose.

7. A product comprising the pet food of any of claims 1 to 6 in a container comprising instructions to administer the pet food to a pet, preferably a companion animal, most preferably a cat.

8. The product of claim 7, wherein the pet food is shelf-stable.

9. The product of any of claim 7 or claim 8, wherein the pet food has a form selected from the group consisting of (a) a semi-solid or solid cake with a whey liquid and (b) a liquid.

10. The product of any of claims 7 to 9, wherein the container is selected from the group consisting of a can, a jar, and a pouch.

11. A method of providing nutrition to a pet, the method comprising administering the pet food of any of claims 1 to 6 to the pet.

12. The method of claim 11, comprising opening a container housing the pet food before the administering.

13. The method of claim 12, wherein the pet food is administered to the pet with addition of any further ingredients after the opening of the container or with addition of the pet food to another pet food, preferably dry kibbles.

14. The method of any of claims 11 to 13, wherein the pet is selected from the group consisting of a kitten, a young cat, a mature cat, and an elderly cat.

15. The method of any of claims 11 to 14 wherein the pet has at least one condition selected from the group consisting of pregnant female, lactating female, overweight, cardio issues, digestive problems, milk intolerance, and need of hydration.
